(19) United States
(12) Patent Application Publication
(10) Pub. No.: US 2026/0307603 A1
(43) Pub. Date: Oct. 8, 2026

(54) PROTECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Ayana FUJITAKA, Osaka (JP); Hiroshi SUDO, Osaka (JP); Yukinori KITA, Osaka (JP); Takamune KIKUTA, Osaka (JP)

(21) Appl. No.: 19/482,777

(22) PCT Filed: May 1, 2024
(86) PCT No.: PCT/JP2024/016777

§ 371 Date: Nov. 10, 2025

(30) Foreign Application Priority Data
May 11, 2023 (JP) 2023-078787

(51) Int. Cl. B60R 16/02; H02G 3/04; H02G 3/30

(52) U.S. Cl. CPC B60R 16/0215; H02G 3/0437; H02G 3/30

(57) ABSTRACT

A protector (10) is attached to a wire harness (13) disposed in the passenger compartment of a vehicle. The protector (10) comprises: a wire harness accommodation part (21) that accommodates the wire harness (13); and a connection part (22) that is connected to an interior member (15) in the passenger compartment.

### TECHNICAL FIELD

The present disclosure relates to a protector.

### BACKGROUND

When electrical devices are mounted to a conventional vehicle, a wire harness for connecting the electrical devices to each other may be disposed within an occupant compartment of the vehicle (see, for example, Patent Document 1). In this case, the wire harness is usually disposed at a location where it is not exposed, such as inside an interior member that constitutes the occupant compartment.

### PRIOR ART DOCUMENT

### Patent Document

Patent Document 1: JP 2014-151778 A

### SUMMARY OF THE INVENTION

### Problems to be Solved

As described above, when disposing the wire harness inside the interior member, it is necessary to detach and attach the interior member. For this reason, there has been a problem in that the operation of disposing the wire harness is complicated.

An object of the present disclosure is to provide a protector that can improve the ease of arrangement of a wire harness.

### Means to Solve the Problem

The protector of the present disclosure is a protector that is to be mounted to a wire harness to be disposed within an occupant compartment of a vehicle, including: a wire harness housing portion configured to house the wire harness; and a coupling portion configured to be coupled to an interior member in the occupant compartment.

### Effect of the Invention

With a protector according to the present disclosure, it is possible to improve the ease of arrangement of a wire harness.

### BRIEF DESCRIPTION OF THE DRAWINGS

FIG. 1 is a schematic diagram of a vehicle equipped with a protector according to a first embodiment.

FIG. 2 is a perspective view of the protector according to the first embodiment.

FIG. 3 is a cross-sectional view of the protector according to the first embodiment.

FIG. 4 is a perspective view of a protector according to a second embodiment.

FIG. 5 is a cross-sectional view of the protector according to the second embodiment.

### DETAILED DESCRIPTION TO EXECUTE THE INVENTION

### Description of Embodiments of the Present Disclosure

First, embodiments of the present disclosure will be listed and described.
[1] A protector according to the present disclosure is a protector that is to be mounted to a wire harness to be disposed within an occupant compartment of a vehicle, including: a wire harness housing portion configured to house the wire harness; and a coupling portion configured to be coupled to an interior member in the occupant compartment.

With this configuration, it is possible to mount the protector housing the wire harness to the interior member using the coupling portion. As a result, it is possible to improve the ease of arrangement of the wire harness. In addition, with the above protector, it is possible to protect the wire harness using the wire harness housing portion.
[2] In above [1], the interior member may include a floor mat that is laid on a floor member constituting the occupant compartment, and the coupling portion may be configured to be coupled to an edge portion of the floor mat.

With this configuration, the protector housing the wire harness can be mounted to the edge portion of the floor mat. Therefore, without detaching or attaching an interior trim or the like that constitutes the interior member, the wire harness can be disposed within the occupant compartment in a state where the wire harness is covered by the protector and is not exposed.
[3] In above [2], the coupling portion may include a pair of clamping portions for clamping the edge portion of the floor mat in a thickness direction of the floor mat.

With this configuration, by merely clamping the edge portion of the floor mat between the pair of clamping portion, the protector can be easily mounted to the floor mat.
[4] In above [1], the interior member may include a floor member constituting the occupant compartment, and the coupling portion may be configured to be coupled to the floor member.

With this configuration, the protector can be mounted to the floor member constituting the occupant compartment, using the coupling portion.
[5] In above [4], the floor member may include a floor carpet that forms a portion of a surface of the floor member, and a floor forming member that includes an overlapping portion that overlaps a surface of the floor carpet, and the coupling portion may be configured to be inserted between the overlapping portion and the floor carpet and coupled to the overlapping portion.

With this configuration, by merely inserting the coupling portion between the floor carpet and the overlapping portion of the floor forming member, the protector can be easily mounted to the floor member.
[9] In above [5], the coupling portion may include a locking portion configured to catch on the overlapping portion.

With this configuration, using the locking portion of the coupling portion that catches on the overlapping portion of the floor forming member, it is possible to keep the coupling portion from coming loose from between the floor carpet and the overlapping portion.
[7] In any one of above [1] to [6], the protector further including: a protector main body that includes the coupling portion; and a separate member that forms a portion of the wire harness housing portion and is separate from the protector main body, wherein the separate member may include a groove portion in which the wire harness is disposed, and the protector main body may include a lid portion that closes an opening of the groove portion.

With this configuration, the wire harness can be covered by the groove portion of the separate member and the lid portion of the protector main body. Therefore, a configuration can be achieved such that the wire harness is not exposed from the protector.
[8] In above [7], the interior member may include a floor mat that is laid on a floor member constituting the occupant compartment, the coupling portion may include the lid portion and a facing portion that faces the lid portion, and the coupling portion may be configured to clamp an edge portion of the floor mat in a thickness direction of the floor mat, between the lid portion and the facing portion.

With this configuration, by merely clamping the edge portion of the floor mat between the lid portion and the facing portion, the protector can be easily mounted to the floor mat. In addition, by adopting a configuration in which the floor mat is clamped between the lid portion and the facing portion, the wire harness housing portion and the wire harness housed in the wire harness housing portion can be disposed at a position hidden behind the floor mat.
[9] In above [7] or [8], the separate member may include a bottom wall and a pair of side walls extending from the bottom wall and facing each other in a width direction of the protector, the bottom wall and the pair of side walls may cooperate to form the groove portion, and the opening of the groove portion may be formed by end portions of the pair of side walls on the opposite side to the bottom wall.

With this configuration, the bottom wall and the pair of side walls can form the groove portion of the separate member.
[10] In above [9], the protector main body may include a pair of outer wall portions extending from the lid portion and facing each other in the width direction, and in a state where the separate member is mounted between the pair of outer wall portions, the pair of outer wall portions may be positioned outside the pair of side walls along the width direction.

With this configuration, the side walls of the separate member are covered by the outer wall portions of the protector main body, and thus it is possible to improve the rigidity of the wire harness housing portion.
[11] In above [10], the pair of outer wall portions may respectively have supporting portions that support the separate member.

With this configuration, the supporting portions of the respective outer wall portions can keep the separate member from coming off from between the pair of outer wall portions.

### Detailed Embodiments of Present Disclosure

Specific examples of a protector according to the present disclosure will be described below with reference to the drawings. In the drawings, parts of the configurations may be shown in an exaggerated or simplified manner for convenience of description. In addition, dimensional ratios of portions may be different between figures. Note that “tubular” as used in the present specification is not limited to a structure in which a peripheral wall is continuously formed over the entire circumference, but also encompasses a structure in which a plurality of parts are combined to form a tubular shape, or a structure partially having a cutout or the like in the circumferential direction to form, for example, a C-shape. In addition, a “tubular” shape also includes circular shapes, elliptical shapes, and polygonal shapes having sharp or rounded corners.

“Facing” in the present specification refers to surfaces or members being positioned in front of each other, and includes not only cases where they are positioned precisely in front of each other but also cases where they are partially positioned in front of each other. “Facing” in the present specification also includes both cases where two portions are disposed with a member other than the two portions interposed therebetween and cases where nothing is interposed between two portions.

### First Embodiment

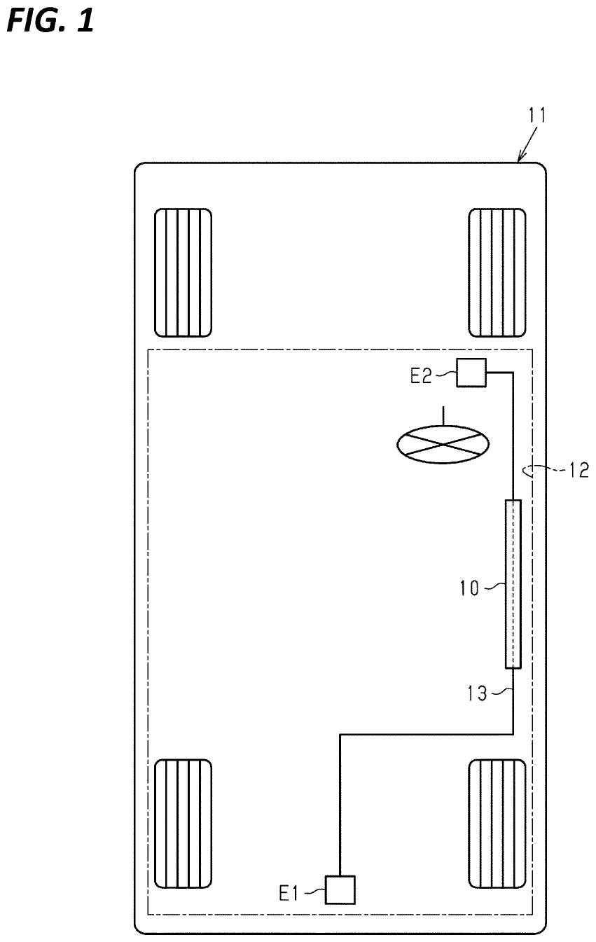

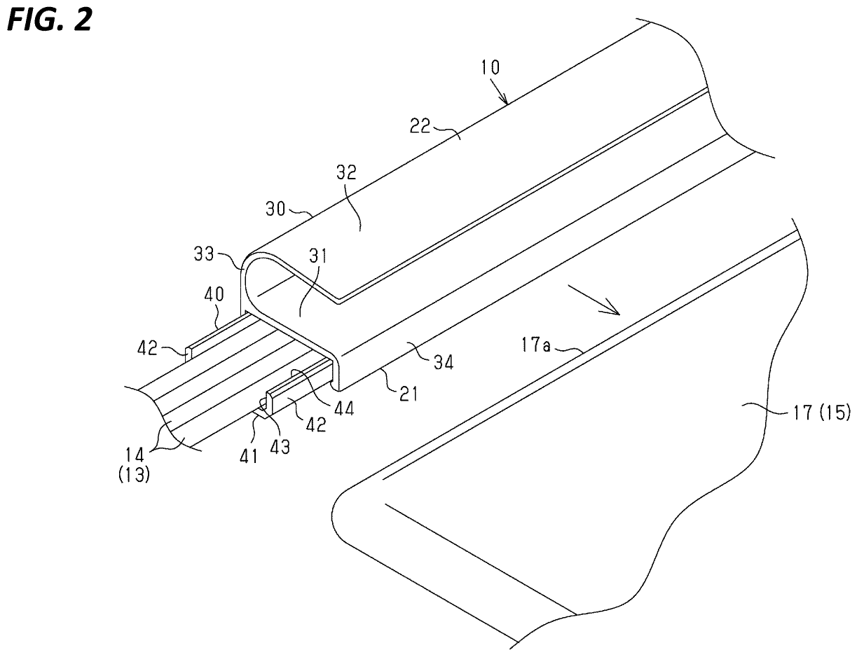

A protector according to a first embodiment will be described below. As shown in FIG. 1, a protector 10 according to the present embodiment is mounted to a wire harness 13 that is disposed within an occupant compartment 12 of a vehicle 11. The wire harness 13 includes one or more electric wires 14 (see FIG. 2). In the present embodiment, the wire harness 13 includes four electric wires 14. The wire harness 13 electrically connects a first electrical device E1 and a second electrical device E2, both of which are mounted to the vehicle 11.

Examples of the first electrical device E1 include a sensor apparatus such as an image capture apparatus. The first electrical device E1 is provided, for example, at a position on the rear side of the occupant compartment 12 of the vehicle 11, such as a back door of the vehicle 11.

Examples of the second electrical device E2 include an electronic control unit (ECU) and the like. The second electrical device E2 is provided, for example, at a position in the vicinity of the front of the occupant compartment 12, inside or outside the occupant compartment 12. Note that the occupant compartment 12 is a compartment of the vehicle 11 that is occupied by occupants including the driver. For example, the occupant compartment 12 may be configured to accommodate or support seats for the occupants.

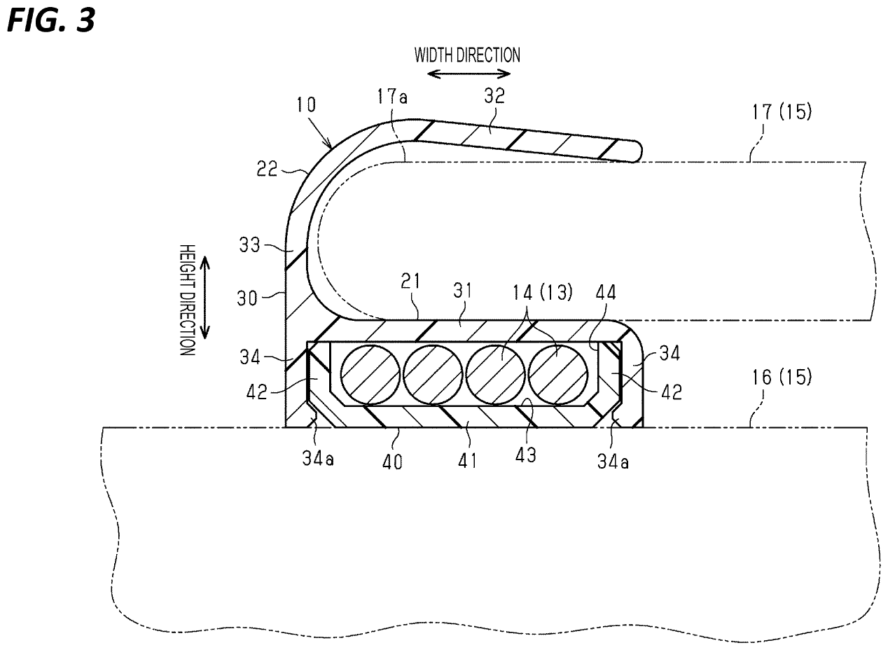

The wire harness 13 that connects the first electrical device E1 and the second electrical device E2 is routed within the occupant compartment 12. The protector 10 protects the wire harness 13 routed in the occupant compartment 12 by covering a predetermined area in the lengthwise direction of the wire harness 13. In addition, the protector 10 enables the wire harness 13 to be mounted to an interior member 15 (see FIG. 3) in the occupant compartment 12.

As shown in FIG. 3, the interior member 15 of the occupant compartment 12 includes, for example, a floor member 16 constituting the occupant compartment 12, and a floor mat 17 laid on the floor member 16. The floor member 16 includes, for example, a floor carpet provided on an upper surface of a sound absorbing and insulating member such as a silencer formed of nonwoven fabric, a step trim provided at an edge portion of the floor carpet, and the like. The protector 10 according to the present embodiment is configured to be mountable to the floor mat 17 that is included in the interior member 15.

### Configuration of Protector 10

As shown in FIGS. 2 and 3, the protector 10 includes a wire harness housing portion 21 that houses the wire harness 13, and a coupling portion 22 that is coupled to the interior member 15. The wire harness housing portion 21 has a shape elongated in the lengthwise direction of the wire harness 13. That is to say, the wire harness housing portion 21 covers a large area in the lengthwise direction of the wire harness 13. The coupling portion 22 of the protector 10 according to the present embodiment is configured to be coupled, for example, to an edge portion 17a of the floor mat 17.

The protector 10 is constituted by, for example, a protector main body 30 having the coupling portion 22, and a separate member 40 separate from the protector main body 30. The separate member 40 forms a portion of the wire harness housing portion 21. The protector main body 30 and the separate member 40 are each formed of, for example, a synthetic resin.

### Configuration of Coupling Portion 22

The coupling portion 22 of the protector main body 30 includes a lid portion 31 and a facing portion 32 that faces the lid portion 31. Specifically, the coupling portion 22 has, for example, an intermediate portion 33 extending from one end of the lid portion 31 in the width direction of the protector 10. The facing portion 32 extends from the intermediate portion 33 and faces the lid portion 31. The lid portion 31 and the facing portion 32 constitute a pair of clamping portions. The coupling portion 22 that includes the lid portion 31, the facing portion 32, and the intermediate portion 33 has a generally U-shape as viewed in the lengthwise direction of the wire harness 13. The coupling portion 22 is configured to clamp the edge portion 17a of the floor mat 17 in the thickness direction of the floor mat 17 between the lid portion 31 and the facing portion 32. The facing portion 32 is bendable in a direction separating away from the lid portion 31. Accordingly, the facing portion 32 and the lid portion 31 elastically clamp the edge portion 17a of the floor mat 17 therebetween.

The protector main body 30 has a pair of outer wall portions 34 extending from the lid portion 31. The outer wall portions 34, for example, extend respectively from the two end portions in the width direction of the lid portion 31. The pair of outer wall portions 34 each form a portion of the wire harness housing portion 21. The pair of outer wall portions 34 face each other in the width direction of the protector 10. A separate member 40 is provided between the pair of outer wall portions 34.

The wire harness housing portion 21 and the coupling portion 22 are arranged in parallel in the height direction of the wire harness housing portion 21. Note that the height direction of the wire harness housing portion 21 is the direction in which a bottom wall 41 of the separate member 40 and the lid portion 31 of the protector main body 30 face each other, and is, for example, the direction in which the outer wall portions 34 extend. In a state where the protector 10 is mounted to the floor mat 17, the wire harness housing portion 21 and the coupling portion 22 are arranged in parallel in the direction perpendicular to the upper surface of the floor member 16. Each of the wire harness housing portion 21 and the coupling portion 22 has an elongated shape along the lengthwise direction of the wire harness 13. Note that the coupling portion 22 may be provided over the entire lengthwise direction of the wire harness housing portion 21 or may be provided partially along the lengthwise direction of the wire harness housing portion 21.

### Configuration of Separate Member 40

The separate member 40 that forms a portion of the wire harness housing portion 21 has an elongated shape along the lengthwise direction of the wire harness 13. The separate member 40 includes the bottom wall 41 and a pair of side walls 42 extending from the bottom wall 41. The pair of side walls 42 face each other in the width direction of the protector 10. The bottom wall 41 and the pair of side walls 42 form a groove portion 43 in the separate member 40. The bottom wall 41 and the pair of side walls 42 are provided, for example, over the entire lengthwise direction of the separate member 40. A cross-sectional shape of the separate member 40 in a transverse direction is, for example, uniform over the entire lengthwise direction of the separate member 40.

A plurality of electric wires 14 of the wire harness 13 are disposed in the groove portion 43 of the separate member 40. In the groove portion 43, the plurality of electric wires 14 are aligned along the width direction of the protector 10, for example. The wire harness 13 that contains the electric wires 14 is drawn out of the protector 10 from one of the two ends of the groove portion 43 in the lengthwise direction of the wire harness housing portion 21. The groove portion 43 of the separate member 40 has an opening 44 that is open upward. The opening 44 is formed by the leading end portions of the pair of side walls 42 on the opposite side to the bottom wall 41. The electric wires 14 are housed in the groove portion 43 through the opening 44, for example.

The lid portion 31 of the protector main body 30 is positioned above the separate member 40. That is to say, the lid portion 31 closes the opening 44 of the groove portion 43. The wire harness housing portion 21 has a tubular shape formed by the lid portion 31 of the protector main body 30 and the bottom wall 41 and the pair of side walls 42 of the separate member 40. The wire harness 13 containing the electric wires 14 is housed in the tubular wire harness housing portion 21. Therefore, the groove portion 43 of the separate member 40 and the lid portion 31 of the protector main body 30 can cover the outer periphery of the wire harness 13. Note that the lid portion 31 according to the present embodiment forms a portion of the coupling portion 22 and a portion of the wire harness housing portion 21.

The separate member 40 is mounted between the pair of outer wall portions 34 of the protector main body 30. The pair of outer wall portions 34 of the protector main body 30 are positioned outside the pair of side walls 42 in the width direction of the protector 10.

The pair of outer wall portions 34 respectively have supporting portions 34a that support the separate member 40. The supporting portions 34a are provided, for example, at the lower end portions of the respective outer wall portions 34. The supporting portions 34a protrude inward in the width direction from the respective outer wall portions 34. The supporting portions 34a each have an elongated shape along the lengthwise direction of the wire harness housing portion 21. Accordingly, the outer wall portions 34 that have the respective supporting portions 34a have a rail-like shape along the lengthwise direction of the wire harness housing portion 21. Note that each supporting portion 34a may be provided over the entire lengthwise direction of the wire harness housing portion 21, or may be provided partially along the lengthwise direction of the wire harness housing portion 21.

The separate member 40 can be attached between the pair of outer wall portions 34 along the lengthwise direction of the wire harness housing portion 21. When attaching the separate member 40 to the wire harness housing portion 21 along the lengthwise direction, the separate member 40 is guided by the pair of outer wall portions 34 having a rail-like shape.

The supporting portions 34a are configured to catch on the respective side walls 42 of the separate member 40 in the height direction of the wire harness housing portion 21. For example, the supporting portions 34a are designed to catch on the lower end portions of the respective side walls 42. Accordingly, the separate member 40 is kept from coming off downward in the height direction from between the pair of outer wall portions 34.

Operations of the first embodiment will be described.

When mounting the first electrical device E1 to the vehicle 11, the protector 10 is used to dispose the wire harness 13 extending from the first electrical device E1, inside the occupant compartment 12.

When mounting the protector 10 to the wire harness 13, first, the wire harness 13 is housed in the groove portion 43 of the separate member 40 in a state of being detached from the protector main body 30. The separate member 40 having the wire harness 13 housed therein is then attached between the pair of outer wall portions 34 of the protector main body 30. Accordingly, the wire harness 13 is housed inside the tubular wire harness housing portion 21.

Next, the protector 10 having the wire harness 13 housed therein is mounted to the floor mat 17. At this time, the edge portion 17a of the floor mat 17 is inserted between the pair of clamping portions of the protector main body 30, i.e., between the lid portion 31 and the facing portion 32. Accordingly, the edge portion 17a of the floor mat 17 is clamped due to elasticity of the facing portion 32, and the protector 10 is fixed to the edge portion 17a of the floor mat 17. In a state where the protector 10 is mounted to the edge portion 17a of the floor mat 17, the wire harness housing portion 21 is positioned between the floor mat 17 and the floor member 16. Accordingly, the wire harness housing portion 21 and the wire harness 13 are disposed at a position hidden behind the floor mat 17.

Effects of the first embodiment will be described.
(1-1) The protector 10 includes the wire harness housing portion 21 that houses the wire harness 13, and the coupling portion 22 that is coupled to the interior member 15 in the occupant compartment 12. With this configuration, the protector 10 housing the wire harness 13 can be mounted to the interior member 15 using the coupling portion 22. As a result, it is possible to improve the ease of arrangement of the wire harness 13. In addition, the wire harness housing portion 21 has an elongated shape along the lengthwise direction of the wire harness 13. For this reason, the wire harness housing portion 21 can protect a large area in the lengthwise direction of the wire harness 13.
(1-2) The interior member 15 includes the floor mat 17 that is laid on the floor member 16 that constitutes the occupant compartment 12. The coupling portion 22 is configured to be coupled to the edge portion 17a of the floor mat 17. With this configuration, the protector 10 housing the wire harness 13 can be mounted to the edge portion 17a of the floor mat 17. Therefore, without detaching and attaching, for example, an interior trim that constitutes the interior member 15, the wire harness 13 can be disposed within the occupant compartment 12 in a mode in which the wire harness 13 is covered by the protector 10 and not exposed.
(1-3) The coupling portion 22 includes the lid portion 31 and the facing portion 32 that faces the lid portion 31. The lid portion 31 and the facing portion 32 form a pair of clamping portions. The coupling portion 22 is configured such that the lid portion 31 and the facing portion 32 clamp the edge portion 17a of the floor mat 17 in the thickness direction of the floor mat 17. With this configuration, the protector 10 can be easily mounted to the floor mat 17 simply by clamping the edge portion 17a of the floor mat 17 between the lid portion 31 and the facing portion 32 functioning as the pair of clamping portions. In addition, by adopting a configuration in which the floor mat 17 is clamped between the lid portion 31 and the facing portion 32, the wire harness housing portion 21 that includes the lid portion 31 and the wire harness 13 can be disposed at a position hidden behind the floor mat 17.
(1-4) The protector 10 includes the protector main body 30 including the coupling portion 22 and the separate member 40 that forms a portion of the wire harness housing portion 21 and is separate from the protector main body 30. The separate member 40 includes the groove portion 43 in which the wire harness 13 is disposed. The protector main body 30 includes the lid portion 31 that closes the opening 44 of the groove portion 43. With this configuration, the groove portion 43 of the separate member 40 and the lid portion 31 of the protector main body 30 can cover the wire harness 13. Therefore, a configuration can be adopted in which the wire harness 13 is not exposed from the protector 10.
(1-5) The separate member 40 includes the bottom wall 41 and the pair of side walls 42 extending from the bottom wall 41 and facing each other in the width direction of the protector 10. The bottom wall 41 and the pair of side walls 42 cooperate to form the groove portion 43 of the separate member 40. The opening 44 of the groove portion 43 is formed by the leading end portions of the pair of side walls 42 on the opposite side to the bottom wall 41. With this configuration, the groove portion 43 of the separate member 40 can be formed by the bottom wall 41 and the pair of side walls 42.
(1-6) The protector main body 30 includes the pair of outer wall portions 34 that extend from the lid portion 31 and face each other in the width direction. In a state where the separate member 40 is mounted between the pair of outer wall portions 34, the pair of outer wall portions 34 are positioned outside the pair of side walls 42 along the width direction. With this configuration, the side walls 42 of the separate member 40 are covered by the respective outer wall portions 34 of the protector main body 30, and thus it is possible to improve the rigidity of the wire harness housing portion 21.
(1-7) The pair of outer wall portions 34 have the respective supporting portions 34a that support the separate member 40. With this configuration, the supporting portions 34a of the outer wall portions 34 can keep the separate member 40 from coming off from between the pair of outer wall portions 34.

### Second Embodiment

A protector according to a second embodiment will be described below. In the following description of the second embodiment, differences from the first embodiment will be mainly described, and the same reference numerals are given to constituent elements identical or corresponding to those in the first embodiment, and a portion or the entirety of a description of such constituent elements may be omitted.

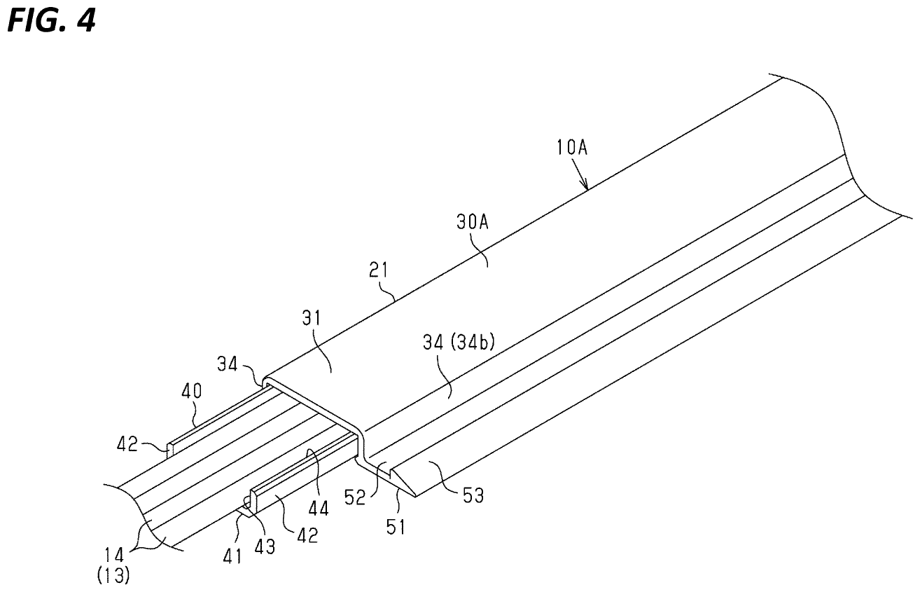

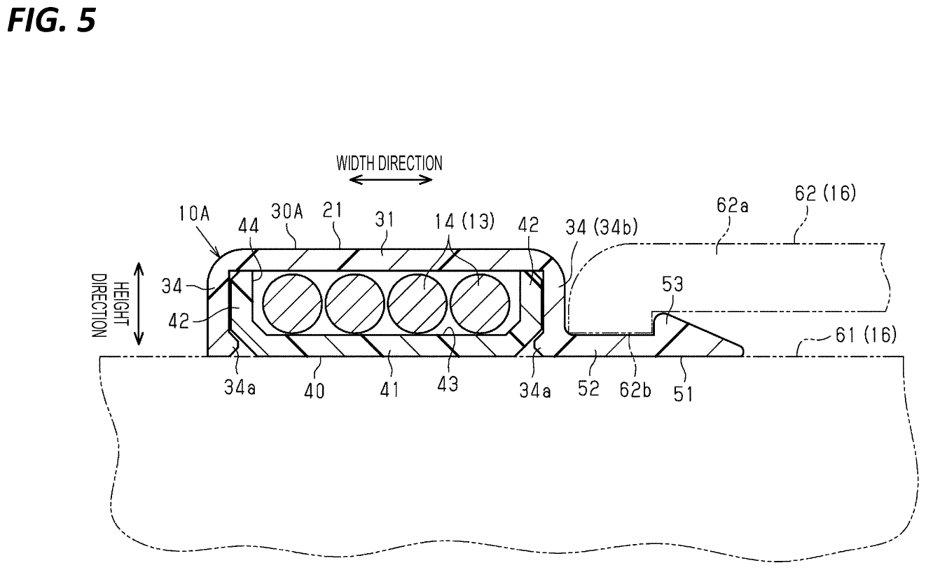

As shown in FIGS. 4 and 5, a protector 10A according to the second embodiment includes a wire harness housing portion 21 that houses the wire harness 13, and a coupling portion 51 that can be coupled to the interior member 15 of the occupant compartment 12.

As shown in FIG. 5, the coupling portion 51 according to the present embodiment is, for example, coupled to the floor member 16 that constitutes the occupant compartment 12. The floor member 16 is included in the interior member 15 of the occupant compartment 12. The floor member 16 includes a floor carpet 61 forming a portion of the surface the floor member 16, and a floor forming member 62. The floor forming member 62 includes an overlapping portion 62a that overlaps the surface of the floor carpet 61. Examples of the floor forming member 62 include a step trim provided at an edge portion of the floor carpet 61, and a rail-forming member of a sliding seat of the vehicle 11.

The protector 10A includes a protector main body 30A having the coupling portion 51, and a separate member 40. In the protector 10A, the wire harness housing portion 21 and the coupling portion 51 are arranged in parallel in the width direction of the protector 10A. The coupling portion 51 is extended from one (an outer wall portion 34b) of a pair of outer wall portions 34, for example. The coupling portion 51 includes, for example, an extended portion 52 that extends from a lower end of the outer wall portion 34b along the width direction of the protector 10A, and a locking portion 53 that protrudes upward from the extended portion 52. The extended portion 52 is provided at the same position as the bottom wall 41 of the separate member 40 in the height direction of the wire harness housing portion 21, for example.

The coupling portion 51 is inserted between the floor carpet 61 and the overlapping portion 62a of the floor forming member 62. The coupling portion 51 is then kept from coming loose from between the floor carpet 61 and the overlapping portion 62a by the locking portion 53 catching on the overlapping portion 62a. The floor forming member 62 has, for example, a locked portion 62b protruding from the rear surface of the floor forming member 62. The locking portion 53 is configured to catch on the locked portion 62b.

Effects of the second embodiment will be described.
(2-1) The protector 10 includes the wire harness housing portion 21 that houses the wire harness 13, and the coupling portion 51 that is coupled to the interior member 15 in the occupant compartment 12. With this configuration, the protector 10 housing the wire harness 13 can be mounted to the interior member 15 using the coupling portion 51. As a result, it is possible to improve the ease of arrangement of the wire harness 13.
(2-2) The coupling portion 51 of the protector 10A is configured to be coupled to the floor member 16. With this configuration, the protector 10 can be mounted to the floor member 16 constituting the occupant compartment 12 using the coupling portion 51.
(2-3) The floor member 16 includes the floor carpet 61 that forms a portion of the surface of the floor member 16, and the floor forming member 62 that includes the overlapping portion 62a that overlaps the surface of the floor carpet 61. The coupling portion 51 is configured to be inserted between the overlapping portion 62a and the floor carpet 61, and be coupled to the overlapping portion 62a. With this configuration, by merely inserting the coupling portion 51 between the floor carpet 61 and the overlapping portion 62a of the floor forming member 62, the protector 10 can be easily mounted to the floor member 16.
(2-4) The coupling portion 51 includes the locking portion 53 that catches on the overlapping portion 62a. With this configuration, using the locking portion 53 of the coupling portion 51 that catches on the overlapping portion 62a of the floor forming member 62, it is possible to keep the coupling portion 51 from coming loose from between the floor carpet 61 and the overlapping portion 62a.

The above embodiments can be modified and implemented as follows. The above embodiments and the modified example below can be combined unless they are technically inconsistent.
In the protector 10 according to the first embodiment, the wire harness housing portion 21 and the coupling portion 22 may be arranged in parallel in the width direction of the protector 10. In this case, the pair of clamping portions for clamping the floor mat 17 may be provided separately from the lid portion 31.
A target object to which the protector 10A according to the second embodiment is mounted is not limited to the floor member 16 of the occupant compartment 12. For example, the target object to which the protector 10A is mounted may be a side wall or a ceiling member of the occupant compartment 12. For example, when the target object to which the protector 10A is mounted is a ceiling member, a configuration may be adopted in which the coupling portion 51 is inserted between a roof lining and an interior trim included in the ceiling member and the locking portion 53 of the coupling portion 51 is caught on the interior trim.
The protectors 10 and 10A according to the above embodiments may have a configuration in which the separate member 40 is omitted. That is to say, a configuration may be adopted in which the entirety of the wire harness housing portion 21 is provided in the protector main bodies 30 and 30A.
The protector main bodies 30 and 30A according to the above embodiments may have a configuration in which the pair of outer wall portions 34 are omitted.
The number of the electric wires 14 included in the wire harness 13 is not limited to the above embodiments, and may be three or less, or five or more.
As in the non-limiting examples shown in FIGS. 3 and 5, the protector main body 30 or 30A of the protector 10 may be referred to as a synthetic resin one-piece component. The separate member 40 may be referred to as an electric wire receiving tray.
As in the non-limiting examples shown in FIGS. 3 and 5, the groove portion 43 of the separate member 40 may include the bottom wall 41 having a length and a width and the side walls 42 having a length and a height. The side walls 42 may include base end portions and leading end portions that define the height of the side walls 42, and the base end portions being continuous with the bottom wall 41, and the leading end portions being located on the opposite side to the bottom wall 41. The groove portion 43 of the separate member 40 may have a depth and a width corresponding to the number of electric wires 14 of the wire harness 13 and the thickness of the electric wires 14 such that the electric wires 14 are less likely to move within the groove portion 43 due to, for example, vibration of the vehicle. As shown in the examples shown in FIGS. 3 and 5, the depth and width of the groove portion 43, in other words, the width of the bottom wall 41 and the height of the side walls 42, may be determined in advance according to the number of electric wires 14 and the thickness of the electric wires 14, such that a subset of electric wires 14 is directly supported by or fitted with the bottom wall 41 and the two side walls 42 of the groove portion 43 and the lid portion 31 in a state where the separate member 40 is covered by the lid portion 31 of the protector main body 30 (30A). As shown in FIGS. 3 and 5, the plurality of electric wires 14 of the wire harness 13 may be housed in the groove portion 43 as a single-layer subset in which the plurality of electric wires 14 are arranged parallel to each other without layering, for example. The groove portion 43 may be adapted to the single-layer subset of electric wires 14 of the wire harness 13.
As in the non-limiting examples shown in FIGS. 3 and 5, the base end portions of the side walls 42 may include bent portions, respectively. The bent portions of the side walls 42 may be each referred to as a key groove that is engaged with the corresponding supporting portion 34a of the protector main body 30, and the supporting portion 34a of the protector main body 30 may be referred to as a key. The engagement between the key groove and the key is advantageous in reducing play between the separate member 40 and the protector main body 30.
The embodiments and modified examples disclosed herein are examples in all respect, and the present invention is not limited to illustrations of these. That is, the scope of the present invention is indicated by the claims, and is intended to include all modifications that are within the meanings and the scope that are equivalent to those of the claims.

### LIST OF REFERENCE NUMERALS

10, 10A Protector
11 Vehicle
12 Occupant compartment
13 Wire harness
14 Electric wire
15 Interior member
16 Floor member
17 Floor mat
17a Edge portion
21 Wire harness housing portion
22, 51 Coupling portion
30, 30A Protector main body
31 Lid portion (one of a pair of clamping portions)
32 Facing portion (the other of the pair of clamping portions)
33 Intermediate portion
34 (34b) Outer wall portion
34a Supporting portion
40 Separate member
41 Bottom wall
42 Side wall
43 Groove portion
44 Opening
52 Extended portion
53 Locking portion
61 Floor carpet
62 Floor forming member
62a Overlapping portion
62b Locked portion
E1 First electrical device
E2 Second electrical device

1. A protector that is to be mounted to a wire harness to be disposed within an occupant compartment of a vehicle, comprising:
a wire harness housing portion configured to house the wire harness; and
a coupling portion configured to be coupled to an interior member in the occupant compartment.

2. The protector according to claim 1,
wherein the interior member includes a floor mat that is laid on a floor member constituting the occupant compartment, and
the coupling portion is configured to be coupled to an edge portion of the floor mat.

3. The protector according to claim 2,
wherein the coupling portion includes a pair of clamping portions for clamping the edge portion of the floor mat in a thickness direction of the floor mat.

4. The protector according to claim 1,
wherein the interior member includes a floor member constituting the occupant compartment, and
the coupling portion is configured to be coupled to the floor member.

5. The protector according to claim 4,
wherein the floor member includes a floor carpet that forms a portion of a surface of the floor member, and a floor forming member that includes an overlapping portion that overlaps a surface of the floor carpet, and
the coupling portion is configured to be inserted between the overlapping portion and the floor carpet and coupled to the overlapping portion.

6. The protector according to claim 5,
wherein the coupling portion includes a locking portion configured to catch on the overlapping portion.

7. The protector according to claim 1, further comprising:
a protector main body that includes the coupling portion; and
a separate member that forms a portion of the wire harness housing portion and is separate from the protector main body,
wherein the separate member includes a groove portion in which the wire harness is disposed, and
the protector main body includes a lid portion that closes an opening of the groove portion.

8. The protector according to claim 7,
wherein the interior member includes a floor mat that is laid on a floor member constituting the occupant compartment,
the coupling portion includes the lid portion and a facing portion that faces the lid portion, and
the coupling portion is configured to clamp an edge portion of the floor mat in a thickness direction of the floor mat, between the lid portion and the facing portion.

9. The protector according to claim 7,
wherein the separate member includes a bottom wall and a pair of side walls extending from the bottom wall and facing each other in a width direction of the protector,
the bottom wall and the pair of side walls cooperate to form the groove portion, and
the opening of the groove portion is formed by end portions of the pair of side walls on the opposite side to the bottom wall.

10. The protector according to claim 9,
wherein the protector main body includes a pair of outer wall portions extending from the lid portion and facing each other in the width direction, and
in a state where the separate member is mounted between the pair of outer wall portions, the pair of outer wall portions are positioned outside the pair of side walls along the width direction.

11. The protector according to claim 10,
wherein the pair of outer wall portions respectively have supporting portions that support the separate member.
